(19) United States
(12) Patent Application Publication
(10) Pub. No.: US 2020/0169307 A1
(43) Pub. Date: May 28, 2020

(54) CONTROL SIGNALING

(71) Applicant: NOKIA SOLUTIONS AND NETWORKS OY, Espoo (FI)

(72) Inventors: Sami-Jukka Hakola, Kempele (FI); Esa Tapani Tiirola, Kempele (FI); Kari Pekka Pajukoski, Oulu (FI)

(21) Appl. No.: 16/775,199

(22) Filed: Jan. 28, 2020

Related U.S. Application Data
(62) Division of application No. 15/738,276, filed on Dec. 20, 2017.

(51) Int. Cl. H04B 7/06; H04B 7/0413; H04W 72/04

(52) U.S. Cl. CPC H04B 7/0617; H04B 7/0413; H04B 7/022; H04W 72/042; H04W 72/0413

(57) ABSTRACT

An aspect of the invention is in relation to an apparatus comprising:

at least one processor and at least one memory including a computer program code, the at least one memory and the computer program code configured to, with the at least one processor, cause the apparatus at least to: allocate, by a network node, at least one sector portion beam radiation pattern for downlink common control signaling; configure the downlink common control signaling in a sector portion beam radiation pattern specific manner; define a sector portion beam radiation pattern based association between the downlink common control signaling configuration and an uplink signaling configuration, and convey information on the association for uplink signaling.

### CROSS-REFERENCE TO RELATED APPLICATIONS

This application is a divisional of U.S. application Ser. No. 15/738,276, filed Dec. 20, 2017, entitled “CONTROL SIGNALING” which is a national stage entry of International Application No. PCT/EP2015/064772, filed Jun. 30, 2015, entitled “CONTROL SIGNALING” which are hereby incorporated by reference in their entireties.

### TECHNICAL FIELD

The invention relates to communications.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

In radio communications, multiple-input and multiple-output, or MIMO, may be used as a method for multiplying the capacity of a radio link using multiple transmission and reception antennas to exploit multipath propagation. MIMO may also be used also as a method for coverage extension. In future radio networks, such as 5G, one of the key technical components is massive MIMO. Massive MIMO (also known as Large-Scale Antenna Systems, Very Large MIMO, Hyper MIMO, Full-Dimension MIMO and ARGOS) uses a large number of service antennas (e.g., hundreds or thousands) that are operated coherently and adaptively.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: allocate, by a network node, at least one sector portion beam radiation pattern for downlink common control signaling; configure the downlink common control signaling in a sector portion beam radiation pattern specific manner; define a sector portion beam radiation pattern based association between the downlink common control signaling configuration and an uplink signaling configuration, and convey information on the association for uplink signaling.

According to an aspect of the present invention, there is provided an apparatus comprising: at least one processor and at least one memory including a computer program code, the at least one memory and the computer program code configured to, with the at least one processor, cause the apparatus at least to: receive, by a user device, a sector portion beam radiation pattern based association between a downlink common control signaling configuration and an uplink signaling configuration, and configure uplink signaling in a sector portion beam radiation pattern specific manner based on the sector portion beam radiation pattern based association.

According to yet another aspect of the present invention, there is provided a method comprising: allocating, by a network node, at least one sector portion beam radiation pattern for downlink common control signaling; configuring the downlink common control signaling in a sector portion beam radiation pattern specific manner; defining a sector portion beam radiation pattern based association between the downlink common control signaling configuration and an uplink signaling configuration, and conveying information on the association for uplink signaling.

According to yet another aspect of the present invention, there is provided a method comprising: receiving, by a user device, a sector portion beam radiation pattern based association between a downlink common control signaling configuration and an uplink signaling configuration, and configuring uplink signaling in a sector portion beam radiation pattern specific manner based on the sector portion beam radiation pattern based association.

According to yet another aspect of the present invention, there is provided an apparatus comprising: means for allocating, by a network node, at least one sector portion beam radiation pattern for downlink common control signaling; means for configuring the downlink common control signaling in a sector portion beam radiation pattern specific manner; means for defining a sector portion beam radiation pattern based association between the downlink common control signaling configuration and an uplink signaling configuration, and means for conveying information on the association for uplink signaling.

According to yet another aspect of the present invention, there is provided an apparatus comprising: means for receiving, by a user device, a sector portion beam radiation pattern based association between a downlink common control signaling configuration and an uplink signaling configuration, and means for configuring uplink signaling in a sector portion beam radiation pattern specific manner based on the sector portion beam radiation pattern based association.

According to yet another aspect of the present invention, there is provided a computer program, comprising program code portions for controlling executing of a process, the process comprising: allocating, by a network node, at least one sector portion beam radiation pattern for downlink common control signaling; configuring the downlink common control signaling in a sector portion beam radiation pattern specific manner; defining a sector portion beam radiation pattern based association between the downlink common control signaling configuration and an uplink signaling configuration, and conveying information on the association for uplink signaling.

According to yet another aspect of the present invention, there is provided a computer program, comprising program code portions for controlling executing of a process, the process comprising: receiving, by a user device, a sector portion beam radiation pattern based association between a downlink common control signaling configuration and an uplink signaling configuration, and configuring uplink signaling in a sector portion beam radiation pattern specific manner based on the sector portion beam radiation pattern based association.

### BRIEF DESCRIPTION OF THE DRAWINGS

Some embodiments of the present invention are described below, by way of example only, with reference to the accompanying drawings, in which

FIG. 1 illustrates an example of a system;

FIG. 2 is a flow chart;

FIG. 3 shows an example of association;

FIG. 4 is another flow chart;

FIGS. 5a and 5b shows further examples;

FIG. 6 illustrates examples of apparatuses, and

FIG. 7 illustrates other examples of apparatuses.

### DETAILED DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

Embodiments are applicable to any user device, such as a user terminal, as well as to any network element, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are 5G, the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties. Another example of a suitable communications system is the 5G concept. It is assumed that radio network architecture in 5G may be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates. 5G will likely be comprised of more than one radio access technology (RAT), each optimized for certain use cases and/or spectrum. 5G mobile communications will have a wider range of use cases and related applications including video streaming, augmented reality, different ways of data sharing and various forms of machine type applications, including vehicular safety, different sensors and real-time control.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent. Some other technology advancements probably to be used are Software-Defined Networking (SDN), Big Data, and all-IP, which may change the way networks are being constructed and managed.

FIG. 1 shows a part of a radio access network based on E-UTRA, LTE, LTE-Advanced (LTE-A) or LTE/EPC (EPC=evolved packet core, EPC is enhancement of packet switched technology to cope with faster data rates and growth of Internet protocol traffic). E-UTRA is an air interface of LTE Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1 shows user devices 100 and 102 configured to be in a wireless connection on one or more communication channels 104 and 106 in a cell with a (e)Node B 108 providing the cell. The physical link from a user device to a (e)NodeB is called uplink or reverse link and the physical link from the (e)NodeB to the user device is called downlink or forward link.

Two other nodes (eNodeBs) are also provided, namely 114 and 116 which may have communications channels 118 and 120 to eNode B 108. The nodes may belong to the network of a same operator or to the networks of different operators. It should be appreciated that the number of nodes may vary, as well as the number of networks. User devices communicating with nodes 114 and 116 are not shown due to the sake of clarity. The nodes may have connections to other networks, as well.

The NodeB, or advanced evolved node B (eNodeB, eNB) in LTE-Advanced, is a computing device configured to control the radio resources of communication system it is coupled to. The (e)NodeB may also be referred to as a base station, an access point or any other type of interfacing device including a relay station capable of operating in a wireless environment.

The (e)NodeB includes or is coupled to transceivers. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

A communications system typically comprises more than one (e)NodeB in which case the (e)NodeBs may also be configured to communicate with one another over links, wired or wireless, designed for the purpose. These links may be used for signaling purposes.

The communication system is also able to communicate with other networks, such as a public switched telephone network or the Internet 112. The communication network may also be able to support the usage of cloud services. It should be appreciated that (e)NodeBs or their functionalities may be implemented by using any node, host, server or access point etc. entity suitable for such a usage.

The communication system may also comprise a central control entity, or a like, providing facilities for networks of different operators to cooperate for example in spectrum sharing.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction.

The user device (or in some embodiments a layer 3 relay node or a self-backhauling node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1, user devices are depicted to include 2 antennas only for the sake of clarity. The number of reception and/or transmission antennas may naturally vary according to a current implementation.

Additionally, although the apparatuses have been depicted as single entities, different units, processors and/or memory units (not all shown in FIG. 1) may be implemented.

It is obvious for a person skilled in the art that the depicted system is only an example of a part of a radio access system and in practice, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeBs of FIG. 1 may provide any kind of these cells. A cellular radio system may be implemented as a multilayer network including several kinds of cells. Typically, in multilayer networks, one node B provides one kind of a cell or cells, and thus a plurality of (e) Node Bs are required to provide such a network structure.

For fulfilling the need for improving the deployment and performance of communication systems, the concept of “plug-and-play” (e)NodeBs has been introduced. Typically, a network which is able to use “plug-and-play” (e)Node Bs, includes, in addition to Home (e)NodeBs (H(e)nodeBs), a home node B gateway, or HNB-GW (not shown in FIG. 1). A HNB Gateway (HNB-GW), which is typically installed within an operator's network may aggregate traffic from a large number of HNBs back to a core network.

Massive MIMO provides the possibility to focus the transmission and reception of signal energy into ever-smaller regions of space. This brings improvements in throughput, coverage and energy efficiency, in particularly when combined with simultaneous scheduling of a large number of user terminals (e.g., tens or hundreds). The spectral efficiency gain in massive MIMO is obtained primarily by means of Multi-user MIMO scheduling. Other benefits of massive MIMO include robustness to interference and intentional jamming. Certain implementation options of massive MIMO, especially those relying on analog beamforming may have reduced performance (e.g. compared to fully digital architecture) in terms of certain performance metrics, such as latency. Integrating large scale antenna arrays into the air interface design of 5G systems in the cmWave or mmWave bands is one of the key design targets. The high bandwidth systems at mmWave may not be bandwidth or interference limited, but tend to be path-loss limited. As a result, the emphasis with MIMO technology will initially be on providing power gain through beamforming. Required antenna gains lead to the situation that sector beams are not always feasible and that has an impact to design of the control plane. In the LTE, typically control plane signaling, such as downlink synchronization signaling, cell broadcast signaling, LTE RACH msg2 (i.e. signaling transmitted by BS (eNodeB) as a response to UE's initial, contention based RACH) and uplink RACH (random access channel, RACH), operates under sector wide beams (beam pattern in horizontal plane covers the angular spread of the sector). With massive MIMO, it has to be designed how control plane related signaling can be implemented in the beam domain, i.e. when using beams more narrow than sector wide beams. In other words, it has to be designed how beam-based control plane which does not require a sector beam to operate can be facilitated.

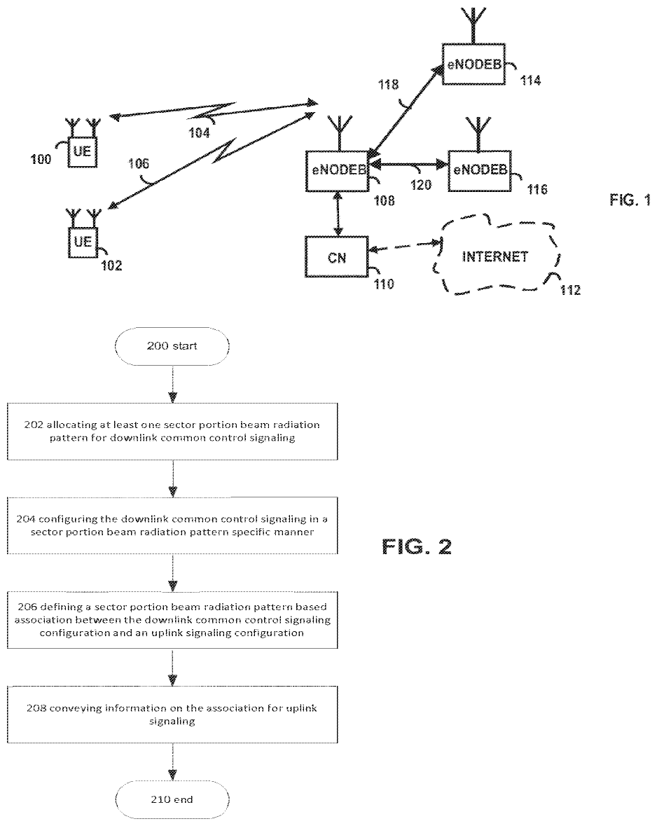

In the following, an embodiment for MIMO operation is disclosed by means of FIG. 2. The embodiment may be carried out by a network node, host, server, etc. The embodiment is suitable for sequential downlink (DL)/uplink (UL) control signals linked to each other. LTE terminology is used in the examples for the sake of clarity, but it should not be taken as limiting the applicability of embodiments.

The embodiment starts in block 200.

In block 202, at least one sector portion beam radiation pattern is allocated for downlink common control signaling.

Term “sector portion beam radiation pattern” may mean an antenna pattern covering at least part of the sector wide antenna beam radiation pattern. This may be defined in 2D space, wherein two dimensions correspond to horizontal (azimuth) domain and vertical (elevation/zenith) domain. Another option is to make in 1D domain only (i.e. horizontal domain or vertical domain). Typically, a radiation pattern or antenna pattern defines the variation of the power radiated by an antenna as a function of the direction away from the antenna. Directional antennas typically have a single peak direction in the radiation pattern (main lobe). A sector antenna is a type of a directional antenna with a sector-shaped radiation pattern.

An example of downlink common control signaling is a discovery signal, typically a periodic discovery signal. Discovery signal may be considered as a “beacon” or pilot signal facilitating a user device to discover a cell. UE may be able to make cell discovery (or perform radio resource management, RRM, measurement) based on a single discovery signal occasion.

In block 204, the downlink common control signaling is configured in a sector portion beam radiation pattern specific manner. In other words, control signaling is not configured in a sector wide radiation pattern manner, but the configuration is made to smaller portions of the antenna sector. Configuration may mean radio resource configuration.

In block 206, a sector portion beam radiation pattern based association between the downlink common control signaling configuration and an uplink signaling configuration is defined.

An association may indicate resources for downlink common control signaling feedback by giving a link between downlink (DL)->uplink (UL) and/or UL->DL resources as indicated in FIG. 3. UL resources indicated by an association typically comprise time difference between downlink and uplink transmissions or time windows for such operations (if downlink and uplink transmission are taken place at different time instants, a radio apparatus are not forced to transmit and receive simultaneously) and physical resources for random access procedure (such as PRACH) for a cell access. The association may comprise an association between downlink and uplink (common control) signaling resources and/or between uplink and downlink (common control) signaling resources. It should be appreciated that the defining of an association typically comprises also a configuration or reservation of the associated resources.

It is possible that downlink common control signaling is transmitted for a first time using configured resources (block 204) and a user device transmits a feedback on associated (configured/reserved) resources, and, in a following time instant, the downlink (common control) signaling is transmitted using other downlink resources which are defined by the association, etc. To put it in a simplified manner, an association may comprise a plurality of related resource associations, which are based on an originally made resource configuration. In another option, the same resources are used in all time instants.

In one embodiment, the transmission of the downlink common control signaling is configured into a plurality of transmission time instants, and the structure of the downlink common control signaling is configured to be similar at different transmission time instants among the plurality of sector portion beam radiation patterns. The structure may mean that the information in the downlink common control signaling is the same at different time instants and/or each piece of information is in the same place in the message. In this case, downlink common control signaling may comprise information on transmission of downlink common control signaling with regard to other sector portion beam radiation patterns of the same cell, sector and/or collaboration area (for example in the case several small cells cooperate). This provides user device an option to monitor all relevant beams or sector portion beam radiation patterns in a certain geographical area. In one embodiment, a plurality of sector portion beam radiation patterns are allocated for downlink common control signaling and one of the plurality of the sector portion beam radiation patterns is used for downlink common control signaling, and at least one other of the plurality of the sector portion beam radiation patterns is used for signaling information on the downlink common control signaling. The information may be information on other downlink common control signaling transmission explained above.

It should be understood that the association between downlink and uplink common control signaling and between uplink and downlink common control signaling may be independent.

In 208, information on the association for uplink signaling is conveyed. The conveying of the information on the association may be carried out by using downlink common control signaling.

In one embodiment, the information on the association is conveyed as a part of system information in the downlink common control signaling. The downlink common control signaling may also comprise a synchronization signal for downlink synchronization and/or an antenna beam or sector portion beam radiation pattern identification. The antenna beam or the sector portion beam radiation pattern identification may be an identification signal, such as channel status information and reference signal (CSI-RS). CSI-RS signal(s) facilitate channel measurements (called often as channel status information) and coherent detection within the beam. Channel status information typically comprises a channel quality indicator (CQI), precoding matrix indicator (PMI), precoding type indicator (PTI) and/or rank indication (RI). It may indicate also one or more beam/antenna port indexes and related channel status information (CSI). CSI-RS may be precoded (beam-specific) or non-precoded (antenna-specific) depending e.g. on implementation choice. In general, aforementioned channel status information may reflect short or long term measure of the channel conditions. It is supposed that in 5G, similar kind of information is forwarded even it may be called in a different name. When an identification is used, an antenna beam or a sector portion beam radiation pattern may be identified not only based on the identification, such as an identification signal, but also based on transmission time, since when a plurality of sector portion beam radiation patterns are used for downlink common control signaling and/or uplink common control signaling, transmissions in different sector portion beam radiation patterns may take place in different time instants (they can be thought to be a kind of concatenated transmissions). For example, when a node transmits a plurality of beams or sector portion beam radiation patterns simultaneously, it transmits in each of the beams or of the sector portion beam radiation patterns a common synchronization signal and system information as well as an identification signal (beam-based or sector portion beam radiation pattern based). Beams or sector portion beam radiation patterns transmitted simultaneously (in the same time instant) have different identification signals. It should be appreciated that the identification signals may be reused in different time instants.

As presented above, downlink common control signaling may be a discovery signal. The discovery signal may comprise a synchronization signal facilitating DL synchronization, at least one channel status information-reference signal (multiple antenna ports may be used for transmission. Each antenna port may relate to a beam within a cell portion or a cell portion as such) and/or at least one system information (such as physical broadcast channel, PBCH). System information may comprise the sector portion beam radiation pattern based association between the downlink common control signaling configuration and an uplink signaling configuration explained above, system frame number, periodicity of cell portion specific discovery signal (if not predefined), number of channel status information-reference signal antenna ports (time instant—specifically), possible timing and/or information on other downlink common control signaling. System information may be detected using at least one CSI-RS antenna port as a phase reference.

Additionally, other control signals may be transmitted, such a paging channel, DL channel(s) related to random access channel, RACH, procedure, such as RA Msg2/Msg4 and additional system information blocks (e.g. not related to beam-based control plane).

It should be appreciated that transmission of the synchronization signal (including also CSI-RS) and transmission of PBCH may be configured independently of each other. One of the independently configured parameters may be periodicity.

The embodiment ends in block 210. The embodiment may be repeated in several different fashions.

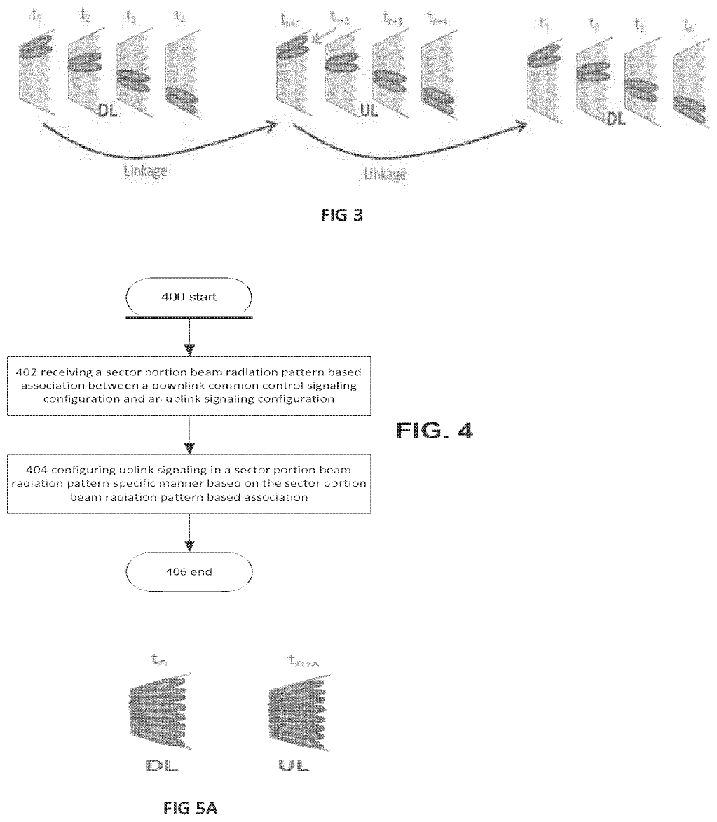

In the following, an embodiment for MIMO operation is disclosed by means of FIG. 4. The embodiment may be carried out by a user device. The embodiment is suitable for sequential downlink (DL)/uplink (UL) control signals linked to each other. LTE terminology is used in the examples for the sake of clarity, but it should not be taken as limiting the applicability of embodiments.

The embodiment starts in block 400.

In block 402, a sector portion beam radiation pattern based association between a downlink common control signaling configuration and an uplink signaling configuration is received.

For obtaining an access to the system, a user device tries first to detect synchronization signals. Similar to the LTE, synchronization signals may carry information related to cell identification and they may be used to derive the resources occupied by channel status information-reference signals. In an embodiment, synchronization signals transmitted during one time instant are virtualized to one or two antenna ports in predetermined manner (independently from antenna port allocation applied for channel status information-reference signal).

The number of antenna ports applied for channel status information-reference signal may vary for example according to the number of available receivers/transmitters. The number of antenna ports for each time instant may be signaled as a part of system information. Hence, when a user device finds the synchronization signal, it may try to detect a physical broadcast channel by using an exhaustive search method with different antenna ports until it receives the system information correctly.

The association may indicate resources for downlink common control signaling feedback by giving a link between DL->UL and/or UL->DL resources. UL resources typically comprise time difference between downlink and uplink transmissions or time windows for such operations (if downlink and uplink transmission are taken place at different time instants, a radio apparatus are not forced to transmit and receive simultaneously) and physical resources for random access procedure (such as PRACH) for a cell access. The association may comprise an association between downlink and uplink common control signaling resources and/or between uplink and downlink common control signaling resources.

In one embodiment, the transmission of the downlink common control signaling is configured into a plurality of transmission time instants, and the structure of the downlink common control signaling is configured to be similar at different transmission time instants among the plurality of sector portion beam radiation patterns. The structure may mean that the information in the downlink common control signaling is the same at different time instants and/or each piece of information is in the same place in the message. In this case, downlink common control signaling may comprise information on transmission of downlink common control signaling with regard to other sector portion beam radiation patterns of the same cell, sector and/or collaboration area (for example in the case several small cells cooperate). This provides user device an option to monitor all relevant beams or sector portion beam radiation patterns in a certain geographical area. In one embodiment, a plurality of sector portion beam radiation patterns are allocated for downlink common control signaling and one of the plurality of the sector portion beam radiation patterns is used for downlink common control signaling, and at least one other of the plurality of the sector portion beam radiation patterns is used for signaling information on the downlink common control signaling. The information may be information on other downlink common control signaling transmission explained above.

In an embodiment, the association is received as a part of system information in the downlink common control signaling and the downlink common control signaling further comprises at least one of the following: a synchronization signal for downlink synchronization and a sector wide beam or sector portion beam identification.

It should be understood that the association between downlink and uplink common control signaling and between uplink and downlink common control signaling may be independent.

In block 404, uplink signaling is configured in a sector portion beam radiation pattern specific manner based on the sector portion beam radiation pattern based association.

Configuring uplink signaling in the sector portion beam radiation pattern specific manner may also comprise configuring the uplink signaling into a plurality of sector portion beam radiation patterns. This may correspond to a hybrid of analog/digital network node receiver architecture wherein the network node may process only a limited number of signals at a time associated with different sector portion beam radiation patters. Additionally, the uplink signaling may be configured into a plurality of transmission time instants, and the structure of the uplink signaling may be configured to be similar at different transmission time instants. This may correspond to a digital network node receiver architecture, where the network node has full flexibility for arranging receiver processing among the available beam/antenna signals. The antenna beam or the sector portion beam radiation pattern identification may be an identification signal, such as channel status information and reference signal (CSI-RS). CSI-RS signal(s) facilitate channel measurements and coherent detection. Channel status information typically comprises a channel quality indicator (CQI), precoding matrix indicator (PMI), precoding type indicator (PTI) and/or rank indication (RI). It may indicate also one or more beam/antenna port indexes and related CSI. It is supposed that in 5G, similar kind of information is forwarded even it may be called in a different name. When an identification is used, an antenna beam or a sector portion beam radiation pattern may be identified not only based on the identification, such as an identification signal, but also based on transmission time, since when a plurality of sector portion beam radiation patterns are used for downlink common control signaling and/or uplink common control signaling, transmissions in different sector portion beam radiation patterns may take place in different time instants (they can be thought to be a kind of concatenated transmissions). For example, when a node transmits a plurality of beams or sector portion beam radiation patterns simultaneously, it transmits in each of the beams or of the sector portion beam radiation patterns a common synchronization signal and system information as well as an identification signal (beam-based or sector portion beam radiation pattern based). Beams or sector portion beam radiation patterns transmitted simultaneously (in the same time instant) have different identification signals. It should be appreciated that the identification signals may be reused in different time instants.

The embodiment ends in block 406. The embodiment may be repeated in several different fashions.

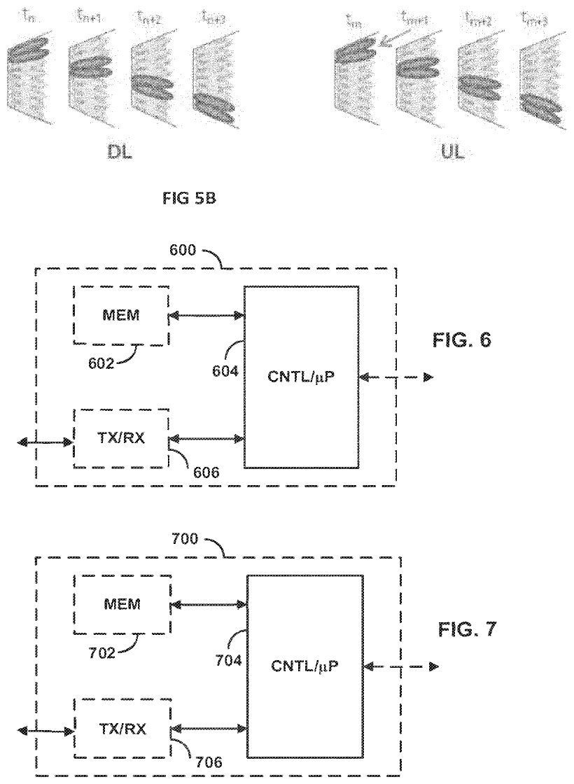

In the following, some examples of downlink (DL) and uplink (UL) sector portion beam radiation pattern specific transmission configurations are depicted by means of FIGS. 5a and 5b. LTE terminology is used in the examples for the sake of clarity, but it should not be taken as limiting the applicability of embodiments.

FIG. 5a shows an example of full digital transceiver architecture. A node with full digital transceiver architecture configures one time instant for its cell portion specific discovery signal transmissions per a discovery period. For the reception of an uplink random access (such as PRACH) corresponding to downlink discovery signal transmission, the node configures one time instant during which it is able to receive a random access (PRACH) preamble or alike from user device. Subsequent DL time instants for the response of the random access (PRACH) are decided by the node within a time window that is also informed to the user devices via a broadcast channel (such as PBCH). The node transmits a synchronization signal and a broadcast channel (PBCH) in one sector portion beam radiation pattern per a transmission time instant and alternates the association between the synchronization signal and the broadcast channel (PBCH) and the sector portion beam radiation pattern specific transmission from one time instant to another one. A channel status information signal (such as a channel status information reference signal, CSI-RS) (precoded) is transmitted per each sector portion beam radiation pattern specific transmission.

FIG. 5b shows an example of hybrid transceiver architecture. A node with hybrid transceiver architecture configures multiple time instants for its cell portion specific discovery signal transmissions. Correspondingly, the node configures the same amount of time instants for the reception of random access (such as PRACH) and utilizes the same radio frequency (RF) beam configuration on those time instants as for the associated sector portion beam radiation pattern specific discovery signal transmissions. Subsequent DL time instants for the response of the random access (PRACH) utilize a fixed time offset from the random access (PRACH) time instants which is informed to user devices via a broadcast channel (such as PBCH). The node transmits a synchronization signal and a broadcast channel (PBCH) in each sector portion beam radiation pattern specific transmission carried out in one time instant. A channel status information signal (such as a channel status information reference signal, CSI-RS) is transmitted per each sector portion beam radiation pattern specific transmission as well.

The steps/points, signaling messages and related functions described above in FIGS. 2 and 4 are in no absolute chronological order, and some of the steps/points may be performed simultaneously or in an order differing from the given one. Other functions may also be executed between the steps/points or within the steps/points and other signaling messages sent between the illustrated messages. Some of the steps/points or part of the steps/points can also be left out or replaced by a corresponding step/point or part of the step/point.

It should be understood that conveying, broadcasting, signaling transmitting and/or receiving may herein mean preparing a data conveyance, broadcast, transmission and/or reception, preparing a message to be conveyed, broadcasted, signaled, transmitted and/or received, or physical transmission and/or reception itself, etc. on a case by case basis. The same principle may be applied to terms transmission and reception as well.

An embodiment provides an apparatus which may be an access point, node, host or server or any other suitable apparatus capable to carry out processes described above in relation to FIG. 2.

It should be appreciated that the apparatus may include or otherwise be in communication with a control unit, one or more processors or other entities capable of carrying out operations according to the embodiments described by means of FIG. 2. It should be understood that each block of the flowchart of FIG. 2 and any combination thereof may be implemented by various means or their combinations, such as hardware, software, firmware, one or more processors and/or circuitry.

FIG. 6 illustrates a simplified block diagram of an apparatus according to an embodiment in relation to FIG. 2.

As an example of an apparatus according to an embodiment, it is shown apparatus 600, such as an access point or (network) node (eNodeB, for example), including facilities in control unit 604 (including one or more processors, for example) to carry out functions of embodiments according to FIG. 2. The facilities may be software, hardware or combinations thereof as described in further detail below.

In FIG. 6, block 606 includes parts/units/modules needed for reception and transmission, usually called a radio front end, RF-parts, radio parts, remote radio head, etc. The parts/units/modules needed for reception and transmission may be comprised in the apparatus or they may be located outside the apparatus the apparatus being operationally coupled to them. The apparatus may also include or be coupled to one or more internal or external memory units.

Another example of apparatus 600 may include at least one processor 604 and at least one memory 602 including a computer program code, the at least one memory and the computer program code configured to, with the at least one processor, cause the apparatus at least to: allocate at least one sector portion beam radiation pattern for downlink common control signaling; configure the downlink common control signaling in a sector portion beam radiation pattern specific manner; define a sector portion beam radiation pattern based association between the downlink common control signaling configuration and an uplink signaling configuration, and convey information on the association for uplink signaling.

It should be understood that the apparatus may include or be coupled to other units or modules etc., such as radio parts or radio heads, used in or for transmission and/or reception. This is depicted in FIG. 6 as optional block 606.

Yet another example of an apparatus comprises means (604) for allocating at least one sector portion beam radiation pattern for downlink common control signaling, means (604) for configuring the downlink common control signaling in a sector portion beam radiation pattern specific manner, means (604) for defining a sector portion beam radiation pattern based association between the downlink common control signaling configuration and an uplink signaling configuration, and means (604, 606) for conveying information on the association for uplink signaling.

It should be understood that the apparatus may include or be coupled to other units or modules etc., such as radio parts or radio heads, used in or for transmission and/or reception. This is depicted in FIG. 6 as optional block 606.

Although the apparatuses have been depicted as one entity in FIG. 6, different modules and memory may be implemented in one or more physical or logical entities.

An embodiment provides an apparatus which may be a node, host or server or any other suitable apparatus capable to carry out processes described above in relation to FIG. 4.

It should be appreciated that the apparatus may include or otherwise be in communication with a control unit, one or more processors or other entities capable of carrying out operations according to the embodiments described by means of FIG. 4. It should be understood that each block of the flowchart of FIG. 4 and any combination thereof may be implemented by various means or their combinations, such as hardware, software, firmware, one or more processors and/or circuitry.

FIG. 7 illustrates a simplified block diagram of an apparatus according to an embodiment in relation to FIG. 4.

As an example of an apparatus according to an embodiment, it is shown apparatus 700, such as a user device, including facilities in control unit 704 (including one or more processors, for example) to carry out functions of embodiments according to FIG. 4. The facilities may be software, hardware or combinations thereof as described in further detail below.

In FIG. 7, block 706 includes parts/units/modules needed for reception and transmission, usually called a radio front end, RF-parts, radio parts, remote radio head, etc. The parts/units/modules needed for reception and transmission may be comprised in the apparatus or they may be located outside the apparatus the apparatus being operationally coupled to them. The apparatus may also include or be coupled to one or more internal or external memory units.

Another example of apparatus 700 may include at least one processor 704 and at least one memory 702 including a computer program code, the at least one memory and the computer program code configured to, with the at least one processor, cause the apparatus at least to: receive a sector portion beam radiation pattern based association between a downlink common control signaling configuration and an uplink signaling configuration, and configure uplink signaling in a sector portion beam radiation pattern specific manner based on the sector portion beam radiation pattern based association.

It should be understood that the apparatus may include or be coupled to other units or modules etc., such as radio parts or radio heads, used in or for transmission and/or reception. This is depicted in FIG. 7 as optional block 706.

Yet another example of an apparatus comprises means (704, 706) for receiving a sector portion beam radiation pattern based association between a downlink common control signaling configuration and an uplink signaling configuration, and means (704) for configuring uplink signaling in a sector portion beam radiation pattern specific manner based on the sector portion beam radiation pattern based association.

It should be understood that the apparatus may include or be coupled to other units or modules etc., such as radio parts or radio heads, used in or for transmission and/or reception. This is depicted in FIG. 7 as optional block 706.

Although the apparatuses have been depicted as one entity in FIG. 7, different modules and memory may be implemented in one or more physical or logical entities.

An apparatus may in general include at least one processor, controller or a unit or module designed for carrying out functions of embodiments operationally coupled to at least one memory unit (or service) and to typically various interfaces. Further, the memory units may include volatile and/or non-volatile memory. The memory unit may store computer program code and/or operating systems, information, data, content or the like for the processor to perform operations according to embodiments described above in relation to FIGS. 2 and/or 4. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be, include or be associated with at least one software application, module, unit or entity configured as arithmetic operation, or as a program (including an added or updated software routine), executed by at least one operation processor. Programs, also called program products or computer programs, including software routines, applets and macros, may be stored in any apparatus-readable data storage medium and they include program instructions to perform particular tasks. The data storage medium may be a non-transitory medium. The computer program or computer program product may also be loaded to the apparatus. A computer program product may comprise one or more computer-executable components which, when the program is run, for example by one or more processors possibly also utilizing an internal or external memory, are configured to carry out any of the embodiments or combinations thereof described above by means of FIGS. 2, 3, 4, 5a and 5b. The one or more computer-executable components may be at least one software code or portions thereof. Computer programs may be coded by a programming language or a low-level programming language.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above. The distribution medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof. For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

What is claimed is:

1. An apparatus comprising:
at least one processor and at least one memory including a computer program code, the at least one memory and the computer program code configured to, with the at least one processor, cause the apparatus at least to:
allocate, by a network node, at least one sector portion beam radiation pattern for downlink common control signaling;
configure the downlink common control signaling in a sector portion beam radiation pattern specific manner;
define a sector portion beam radiation pattern based association between the downlink common control signaling configuration and an uplink signaling configuration, and
convey information on the association for uplink signaling.

2. The apparatus of claim 1, wherein the association comprises a time difference or time window between the downlink common control signaling and the uplink signaling.

3. The apparatus of claim 1, further comprising causing the apparatus to:
configure the transmission of the downlink common control signaling into a plurality of transmission time instants, and
configure a structure of the downlink common control signaling to be similar at different transmission time instants among the allocated at least one sector portion beam radiation pattern.

4. The apparatus of claim 1, wherein the information on the association is conveyed as a part of system information in the downlink common control signaling and the downlink common control signaling further comprises at least one of the following:
a synchronization signal for downlink synchronization and an antenna beam or a sector portion beam radiation pattern identification.

5. The apparatus of claim 1, further comprising causing the apparatus to:
allocate a plurality of sector portion beam radiation patterns for downlink common control signaling;
use one of the plurality of the sector portion beam radiation patterns for downlink common control signaling, and
signal information on the downlink common control signaling using at least one other of the plurality of the sector portion beam radiation patterns.

6. A method comprising:
allocating, by a network node, at least one sector portion beam radiation pattern for downlink common control signaling;
configuring the downlink common control signaling in a sector portion beam radiation pattern specific manner;
defining a sector portion beam radiation pattern based association between the downlink common control signaling configuration and an uplink signaling configuration, and
conveying information on the association for uplink signaling.

7. The method of claim 6, wherein the association comprises a time difference or time window between the downlink common control signaling and the uplink signaling.

8. The method of claim 6, further comprising:
configuring the transmission of the downlink common control signaling into a plurality of transmission time instants, and
configuring a structure of the downlink common control signaling to be similar at different transmission time instants among the allocated at least one sector portion beam radiation pattern.

9. The method of claim 6, wherein the information on the association is conveyed as a part of system information in the downlink common control signaling and the downlink common control signaling further comprises at least one of the following:
a synchronization signal for downlink synchronization and an antenna beam or a sector portion beam radiation pattern identification.

10. The method of claim 6, further comprising:
allocating a plurality of sector portion beam radiation patterns for downlink common control signaling;
using one of the plurality of the sector portion beam radiation patterns for downlink common control signaling, and
signaling information on the downlink common control signaling using at least one other of the plurality of the sector portion beam radiation patterns.
